(19) United States
(12) Patent Application Publication
(10) Pub. No.: US 2007/0130833 A1
(43) Pub. Date: Jun. 14, 2007

(54) Automatic safety gate

(76) Inventor: Ronen Maital, Kadima (IL)

Correspondence Address: Ronen Maital, 3/4 Lemon St., P.O. 2748, Kadima, 60920, IL

(21) Appl. No.: 11/604,236

(22) Filed: Nov. 27, 2006

Related U.S. Application Data
(60) Provisional application No. 60/748,746, filed on Dec. 10, 2005.

(51) Int. Cl. E05F 15/20; G08B 13/18; G08B 23/00

(52) U.S. Cl. 49/31; 340/556; 340/573.4

(57) ABSTRACT

An automatic safety gate or security barrier for preventing infant and/or pet from gaining access through passageways. The gate includes a gate member adapted to be mounted to a wall portion and is movable to a closed position to prevent an infant and/or pet from passing through. The locking mechanism of the gate can be deactivated by a human having predefined properties which are measured by at least one sensor of the gate. Deactivating the locking mechanism allows opening of the gate. The gate can also be manually unlocked by means of a handle. In the case of using a motion sensor, the motion sensor range, angle and height can be adjusted in order to accommodate a variety of openings, such as doors, passageways, stairs, etc.

### CROSS-REFERENCE TO RELATED APPLICATION

This application claims the benefit of U.S. Provisional Patent Application No. 60/748,746, filed Dec. 10, 2005, the entire content of which is incorporated herein by reference.

### FIELD AND BACKGROUND OF THE INVENTION

The present invention relates to safety gates, and more particularly, to an automatic safety gate featuring an identifying sensor, which activates a motorized safety gate when an adult over a predefined height is identified.

Basic principles and details relating to automatic safety gates needed for properly understanding the present invention are provided herein. Complete theoretical descriptions, details, explanations, examples, and applications of these and related subjects and phenomena are readily available in standard references in the fields of mechanics and physics.

Safety gates are useful to inhibit unauthorized access through the safety gate while permitting relatively easy authorized access through the safety gate when desired. Child safety gates are useful to help prevent injuries to children by inhibiting access through the gate by a child while permitting easy access through the gate by an adult. These gates can be mounted, e.g., in doorways, in hallways, between a wall and a stairway railing, or between two stairway railings (such as on a deck). With the gate in place, children are inhibited from accessing areas that are undesirable for the child to access. For example, it may be desirable to inhibit a child from accessing a kitchen, where toxic cleaners may be stored, or a stairway that the child may fall down. Safety gates can also inhibit children from gaining access to a pet or vice versa. A door of the gate can permit access if the door is moved to provide a passageway through the gate.

There is prior art regarding child safety gate or barrier, inhabiting access to undesired areas, activated by button or in remotely way. In addition, there is prior art regarding door or gates or barrier, activated by sensor made of any kind known in the art. However, none of the following indicated prior art refers to safety gate for infant or pets which is activated by a sensor of any kind.

U.S. Pat. No. 6,079,157 issued to Hincher Sr William Matthew describes an illuminated safety or security barrier for preventing children and pets from gaining unauthorized access through passageways. The barrier may optionally be a gate that allows authorized passage. The barrier includes an electrically-operated light disposed to illuminate the barrier directly, to project a visible signal away from the barrier, or both. The barrier includes an electrical system, which has either a battery or plug and cord supplying power, controls, and conductors connected to the light, power source, and controls. Optionally, the controls include a programmable timer, photocell or motion sensor to operationally inhibit the light, and a manual switch to control light intensity. The various controls may be combined. Optionally, a remote controller is provided. However, there is no description of a safety gate automatically operated by an identification sensor.

U.S. Pat. No. 6,016,629 issued to Sylvester Scott Allen describes a pivotally-mounted extendable gate for restricting access by infants or pets, through an opening defined by a pair of opposed vertical surfaces or walls. The gate is pivotal-mounted via hinges pivotally, which are slidably received within sleeves of retaining brackets mounted to one of the walls, attached to the gate. The gate is extendable and retractable via two separate and similar gate members slidably coupled together. A pair of receptacles vertically space apart are mounted on the opposite walls to receive upper and lower portions of one of the gate members. A latch on the upper portion of the gate engages with the upper receptacle is designed for preventing sliding. However, there is no description of a safety gate automatically operated by an identification sensor.

U.S. Pat. No. 6,711,857 issued to Kurt P. Wagnitz describes an infant gate, with a remote activated latch mechanism. The gate includes a gate member adapted for pivotal mounting to a wall section, which is movable to a closed position to prevent an infant from passing through. The movable latch is between a locked position to prevent pivotal movement of the gate, and an unlocked position, for allowing pivotal movement of the gate. The gate also includes an actuator for switching the latch to the unlocked position. Preferably, the actuator is mounted away from the gate segment in a position generally inaccessible to an infant whose access is limited by the infant gate. However, there is no description of a safety gate automatically operated by an identification sensor.

U.S. Pat. No. 6,449,901 issued to Steven Gibree describes a security gate for closing a passage, which has a pair of panels that are movable translationally with respect to one another, in order to alter the effective width of the gate. An actuating mechanism used in forcing the opposite ends of the panels against the sides of the passage includes a handle mounted on one of the panels. The handle controls a latching device operative, which locks the handle in a fixed relationship relative the other panels. Here too, there is no description of a safety that features an safety gate automatically operated by an identification sensor.

U.S. Pat. No. 5,367,829 issued to Crossley David W describes a security gate for children. The security gate includes a pair of gate sections, which slide relative to each other in order vary the effective width of the gate. On the outer vertical side rails of the sections are bumpers. The bumpers on one side rail are extendable to force the bumpers to frictionally engage the sides of an opening to be closed by the gate. Independent of the bumpers, brackets are provided on the vertical outer side rails and the sides of the opening to position the gate in the opening and resist the gate from being pushed out of the opening. The gate may be permanently mounted to the opening using hinges or may be removable from the opening. Here too, there is no description of a safety gate automatically operated by an identification sensor.

U.S. Pat. No. 4,831,777 issued to Johnson Jr Stanley describes an adjustable width doorway safety gate apparatus, comprising two gate segments. One segment of the safety gate apparatus is laterally slidable on the other segment or half segment of the hinged gate. Moreover, the gate's half segments are designed with tongues and grooves and held in a lateral sliding position by double-headed pins. These pins, extending through slots located in the top and bottom bar sections, and spring section latch by means of a stiff, yet flexible, plastic material, operate to lock the gates in adjusted width. Here too, there is no description of a safety gate automatically operated by an identification sensor.

U.S. Pat. No. 5,906,068 issued to Bode Gerd describes a safety gate for restricting passage of a child through an access way, such as a doorway or stairwell. The gate's two parallel, overlapping barrier panels are adjustable, relative to different combinations of widths that fit in different access ways. The contact pads or hinges, which are mounted on one side of the gate, can also be mounted pivotally on a telescoping pole vertically disposed on one side of the access way. The gate is frictionally secured or closed by extendable and retractable engagement feet, adapted to forcibly engage the access wayside wall. The engagement feet are controlled by an outwardly motivating extension mechanism connected via reciprocating linkage with the engagement feet, which provides for reflexive engagement of both feet with approximately equal force, even in access ways having vertically uneven widths. Here too, there is no description of a safety gate automatically operated by an identification sensor.

U.S. Pat. No. 6,161,334 issued to Goodin John Walter describes a child and pet security gate for use in larger passageways. The security gate includes multiple, telescopically sliding panels that extend to close the passageway and retract to minimum width. The extension and retractile, relative sliding movement is progressive; thus, only one panel moves relative to another until it reaches its fully extended or retracted position. The security gate also includes mounting hardware, which permits the gate either to hingeably pivot or to be removed for storage. A latching member is used to securely close the gate and is operable only by an adult. Here too, there is no description of a safety gate automatically operated by an identification sensor.

U.S. Pat. No. 4,944,117 issued to Gebhard Albert W describes an adjustable gate suitable for confining or preventing small children or pets from entering a secure area. The gate is comprised of two connected panels relatively slidable for accommodating doorways of varying widths. A foot-pedal mechanism residing on one of the panels is operated to cause a pair of contact pads to engage the door jamb. By depressing the foot pedal, the contact pad-blocks, which are connected to one side of the gate, and the bumpers associated with the opposite of the gate, engage opposite sides of the door jamb. Here too, there is no description of a safety gate automatically operated by an identification sensor.

U.S. Pat. No. 2,894,952 issued to John Trett describes a movable door, which incorporates a proximity detection system for sensing obstructions in the path of the door. The system comprises an array of transmitter/receiver pairs, each pair comprising a transmitter for transmitting an energy pulse and a receiver adjacent to the transmitter, which are directed to receive any reflected transmitter pulses. The system also comprises a shielding for shielding the receiver from receiving energy pulses directly from the transmitter. At least two transmitter/receiver pairs are mounted on a leading edge or face of the door. The AT least two transmitter/receiver pairs transmit energy pulses in a direction not at a right angle to the leading surface or edge of the door, for monitoring obstructions in the path of the door. Another two transmitter/receiver pairs are mounted on the leading edge or surface of the door. These two transmitter/receiver pairs transmit energy pulses at right angles to the surface, or edge, of the door. Different transmitter/receiver pairs may transmit over different frequencies, and provide the means for suppressing unwanted reflected signals. The means for transmitting data signals on a two-conductor power supply cable for the system is disclosed. Here too, there is no description of a safety gate automatically operated by an identification sensor.

U.S. Pat. No. 5,963,000 issued to Tsutsumi Koji describes a sensor system for a swing door, which include swing-side and approach-side sensors. Each of the sensors includes light-emitters and light-receivers mounted on a swing door. The light-emitters emit light toward a floor, and the light-receivers receive the light reflected from the floor. The light emitted and received provides an object sensing zone having a rectangular shape on the floor with a width equal to, or larger than, the width of the door. The sensing zone includes a main sensing area closer to the door and an auxiliary sensing area extending along the main sensing area. The auxiliary sensing area is disabled when the door moves. Here too, there is no description of a safety gate automatically operated by an identification sensor.

U.S. Pat. No. 4,621,452 issued to Deeg Wyman L describes a sliding door having a safety light beam which travels with and ahead of a closing door. Interruption of the safety light beam by an object in the path of the closing door activates a door control to stop or reverse closure of the door. A stationary transmitter projects a beam of pulsed infrared light toward a convex mirror mounted on the door. The mirror reflects the projected beam ahead of the closing door in a direction transverse to the direction of closure. In one embodiment a plurality of receiver assemblies with overlapping receiving sectors monitor the door's closure path and senses the presence of the moving safety beam. Interruption of the safety light beam is detected in a control unit connected to a unit, which controls a motor that moves the door. In another embodiment, plane mirrors positioned on an arm mounted on, and projecting ahead of the door, establish and reflect safety beams to corresponding receiver assemblies. Here too, there is no description of a safety gate automatically operated by an identification sensor.

U.S. Pat. No. 4,009,476 issued Lutz Erno B describes an apparatus for automatically controlling the operation of a door comprising a microwave transceiver responsive to detect the movement of a randomly moving object and operative to develop a Doppler signal representative of such movement, the Doppler signal being generally sinusoidal with a zero crossing in each cycle, a strobe generator responsive to the Doppler signal and operative to develop a timing pulse upon the occurrence of each such zero crossing, a pair of integrating circuits responsive to the Doppler signal and operative to develop first and second signals of unlike polarity in the absence of the movement and of like polarity in the presence of the movement, a pair of OR gates for detecting the respective polarities of the first and second signals, a sample and hold circuit responsive to the timing pulse and operative to develop a control signal when the first and the second signals are of like polarity, and a relay driver responsive to the control signal and operative to open the door.

To date, the inventor is unaware of prior art teaching of a method and device for automatically operated safety gate featuring an identification sensor.

There is thus a need for, and it would be highly advantageous to have an automatic safety gate featuring identifying sensor which activates a motorized safety gate when an adult over a predefined height is identified

### SUMMARY

The present invention relates to safety gates, and more particularly, to a automatic safety gate featuring an identifying sensor that activates a motorized safety gate when an adult over a predefined height is identified.

Hereinafter, the term “safety gate” refers to any gate or barrier, including, but not limited to, a baby gate, child gate, pet gate, dog gate, stair gate, infant gate, safety barrier, security gate, portable gate, and safety gate for juveniles.

Hereinafter, the term “infant” refers to any baby, child or pet below a predefined height.

Hereinafter, the term “adult” refers to any person or animal over a predefined height.

Thus, according to the present invention, there is provided a safety gate featuring (a) at least one identifying sensor, (b) at least one safety gate, (c) at least one locking mechanism; whereby the identifying sensor is activating the locking mechanism when an adult over a predefined height is identified by the identifying sensor.

According to further features in preferred embodiments of the present invention, the safety gate is a motorized safety gate and the identifying sensor is activating the motorized safety gate when an adult over a predefined height is identified by the identifying sensor.

According to still further features in the described preferred embodiments, the identifying sensor is selected from the group consisting of active detection sensor, passive detection sensor, motion detection sensor, heat detection sensor, acoustic detection sensor, electro-optic sensor, infra-red detection sensor, radio-frequency detection sensor, and microwave detection sensor.

According to another aspect of the present invention, there is provided a safety gate featuring (a) at least one identifying sensor, (b) at least one safety gate, (c) at least one gate actuator; whereby the identifying sensor is activating the gate actuator when an adult over a predefined height is identified by the identifying sensor.

According to further features in preferred embodiments of the present invention, the safety gate is further featuring a locking mechanism.

According to still further features in the described preferred embodiments, the identifying sensor is selected from the group consisting of active detection sensor, passive detection sensor, motion detection sensor, heat detection sensor, acoustic detection sensor, electro-optic sensor, infra-red detection sensor, radio-frequency detection sensor, and microwave detection sensor.

According to another aspect of the present invention, there is provided a safety gate featuring (a) at least one electro-optic identifying sensor, (b) at least one safety gate, (c) at least one gate actuator; whereby the identifying sensor is placed in such a way that an adult, but not an infant, can be inside the vertical opening angle of the identifying sensor.

According to further features in preferred embodiments of the present invention, the identifying sensor has a horizontal opening angle for at least one side of the safety gate.

According to still further features in the described preferred embodiments, the at least one identifying sensor is featuring two identifying sensors having horizontal opening angles for at least one side of the safety gate.

According to another aspect of the present invention, there is provided a safety gate featuring (a) at least one weight sensor, (b) at least one automatic safety gate; whereby the weight sensor measures the body weight of a user and identifies when the user exceeds a predefined threshold.

According to another aspect of the present invention, there is provided a method for operating a motorized safety gate, the method featuring the steps of (a) identifying an adult by using an identifying sensor selected from the group consisting of active detection sensor, passive detection sensor, motion detection sensor, heat detection sensor, acoustic detection sensor, electro-optic sensor, infra-red detection sensor, radio-frequency detection sensor, and microwave detection sensor, (b) unlocking or opening at least one safety gate.

According to further features in preferred embodiments of the present invention, the adult is over a predefined height.

According to still further features in the described preferred embodiments, the adult captures an opening angle larger than a predefined opening angle.

According to still further features in the described preferred embodiments, the adult is using means for identifying himself.

According to still further features in the described preferred embodiments, the identifying sensor is placed in such a way that the adult, but not an infant, can be inside the vertical opening angle of the identifying sensor.

According to still further features in the described preferred embodiments, there is additional step of identifying an infant in the vicinity of the safety gate and not changing the current position of the safety gate when the infant is in the vicinity of the safety gate.

Implementation of the automated safety gate of the present invention involves performing or completing selected tasks or steps manually, semi-automatically, fully automatically, and/or in a combination thereof. Moreover, depending upon actual instrumentation and/or equipment used in implementing a particular preferred embodiment of the disclosed system and corresponding method, several embodiments of the present invention could be achieved by using hardware or by software on any operating system of any firmware, or in any combination thereof.

### BRIEF DESCRIPTION OF THE DRAWINGS

The present invention is herein described, by way of example only, with reference to the accompanying drawings. With specific reference to the drawings, it is stressed that the particulars shown are by way of example and for purposes of illustrative discussion of the preferred embodiments of the present invention only, and are presented in order to provide what is believed to be the most useful and readily understood description of the principles and conceptual aspects of the present invention. In this regard, no attempt is made to show structural details of the present invention in more detail than is necessary for a fundamental understanding of the invention, the description taken with the drawings making apparent to those skilled in the art, how the several forms of the invention may be embodied in practice. Identical structures, elements or parts which appear in more than one figure are preferably labeled with an identical or similar number in all the figures in which they appear. In the drawings:

FIG. 1A is a schematic diagram illustrating the active identifying sensor, in accordance with the present invention;

FIG. 1B is a schematic top view diagram illustrating the active identifying sensor, in accordance with the present invention;

FIG. 2 is a schematic diagram illustrating the vertical opening angle of the identifying sensor, in accordance with the present invention;

FIG. 3A is a schematic top view diagram illustrating the horizontal opening angle of one identifying sensor, in accordance with the present invention;

FIG. 3B is a schematic top view diagram illustrating the horizontal opening angle of two identifying sensors, in accordance with the present invention;

FIG. 4A is another schematic top view diagram illustrating the horizontal opening angle of one identifying sensor, in accordance with the present invention;

FIG. 4B is another schematic top view diagram illustrating the horizontal opening angle of two identifying sensors, in accordance with the present invention;

### DETAILED DESCRIPTION

The present invention relates to safety gates, and more particularly, to an automatic safety gate featuring identifying sensor, which activates a motorized safety gate when an adult over a predefined height is identified.

The present invention provides a mechanism that prevents children from undesirably opening a gate and also enables the unlocking and opening of a gate, hands-free and feet-free.

A significant particular aspect of novelty and inventiveness of the present invention, relates to its ability to allow unencumbered free passage through the opening to an adult over a predefined height, while providing also safe and secure blocking of the passage way to an infant below the predefined height.

Another significant particular aspect of novelty is the fact that automating the gate of the present invention lends itself to being used by people with disabilities. By adding a remote control that activates the actuator, a person in a wheel chair, for example, can easily use the gate of the present invention.

Another significant particular aspect of novelty is the fact that automating the gate lends itself to being used by people with disabilities. By adding a remote control that activates the actuator, a person in a wheel chair, for example, can easily use the gate of the present invention. Moreover, the gate of the present invention introduces the great advantage of remote control activating the lock, especially useful for disabled people.

In an exemplary embodiment option of the present invention, the safety gate of the present invention can be adjusted to fit different sized openings. For example, a top mounted latch with a childproof snap is tilted upwards turning an eccentric cam. The eccentric cam releases the pressure of a locking tongue which, for example, may be both on the upper and lower cross bars of a two sliding segments gate, allowing the two segments to slide longitudinally closer or further to each other.

The present invention is an automatic safety gate. The preferred embodiments of the present invention are discussed in detail below. It is to be understood that the present invention is not limited in its application by the details of the order or sequence of steps of operation or implementation of the method and/or the details of construction, arrangement, and composition of the components of the device set forth in the following description, drawings or examples. While specific steps, configurations and arrangements are discussed, it is to be understood that this is done for illustrative purposes only. A person skilled in the relevant art will recognize that other steps, embodiments, configurations and arrangements can be used without departing from the spirit and scope of the present invention.

The present invention is capable of featuring other embodiments or of being practiced or carried out in various ways. Also, it is to be understood that the phraseology, terminology and notation employed herein are only for purposes of description and should not be regarded as limiting.

As illustrated in the drawings of the present invention, in an exemplary embodiment option of the present invention, the system of the present invention features the following elements: safety gate 10, locking mechanism 11, optional gate actuator 12, and identifying sensor 13.

Safety gate 10 is used for restricting passage of an infant through an access way such as a doorway or stairwell. Safety gate 10 may have any mechanical structure as known in the art. Safety gate 10 may be mounted by using almost any known in the art mounting method.

Locking mechanism 11 is used for locking safety gate 10 and to prevent an infant from opening it. Locking mechanism 11 may be implemented by using almost any known in the art locking mechanism.

Optional gate actuator 12 is used for automatically opening and closing safety gate 10. Automatically opening and closing safety gate 10 may be achieved by any know in the relevant art device, such as, but not limited to, a motorized mechanism, spring, or piston, etc.

Identifying sensor 13 is used for identifying the presence of an adult in its detection range. It is to be understood that the method and corresponding safety gate 10 of the present invention can be implemented in a variety of configurations. For example, identifying sensor 13 may feature many known in the art types of detection mechanisms such as active detection, passive detection, motion detection, heat detection, acoustic detection, electro-optic sensor, infra-red detection, radio frequency detection, or microwaves detection, etc.

Safety gate 10 can be located at any desired place, such as a doorways, hallways, between a wall and, between two stairway railings, outer door window or any other opening. In an optional exemplary embodiment option of the present invention, safety gate 10 is activated automatically by gate actuator 12 and identifying sensor 13. Identifying sensor 13 is located in such a way as to allow access only to an adult approaching safety gate 10.

It is to be understood that identifying sensor 13 can be located at any desired place and does not have to be located in proximity to safety gate 10.

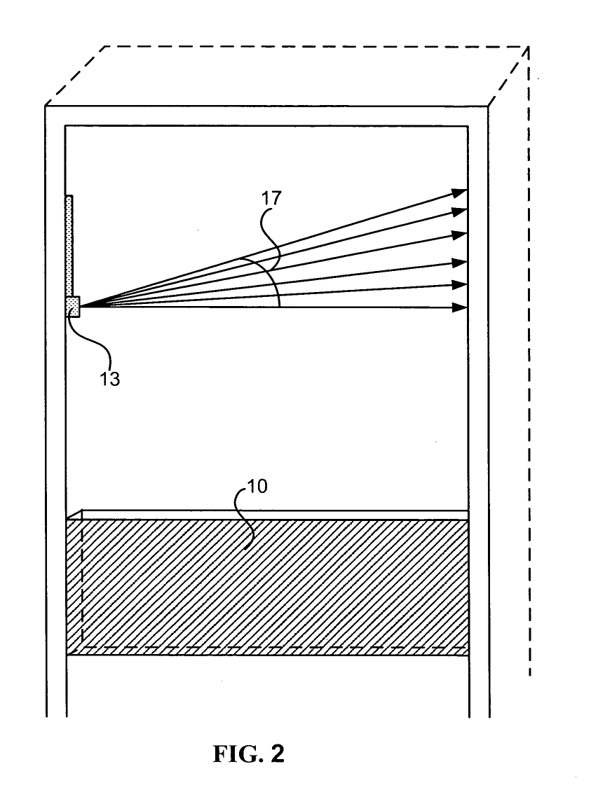

In the case where identifying sensor 13 is an electro-optic sensor, identifying sensor 13 features a vertical predefined opening angle 17 and horizontal predefined opening angle 14. Referring to FIG. 2, in an exemplary embodiment option of the present invention, identifying sensor 13 is placed in such a way that an adult, but not an infant, can be inside vertical opening angle 14.

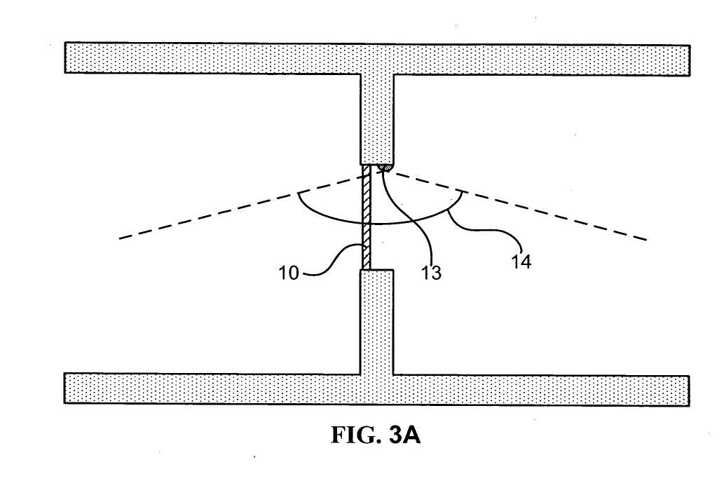

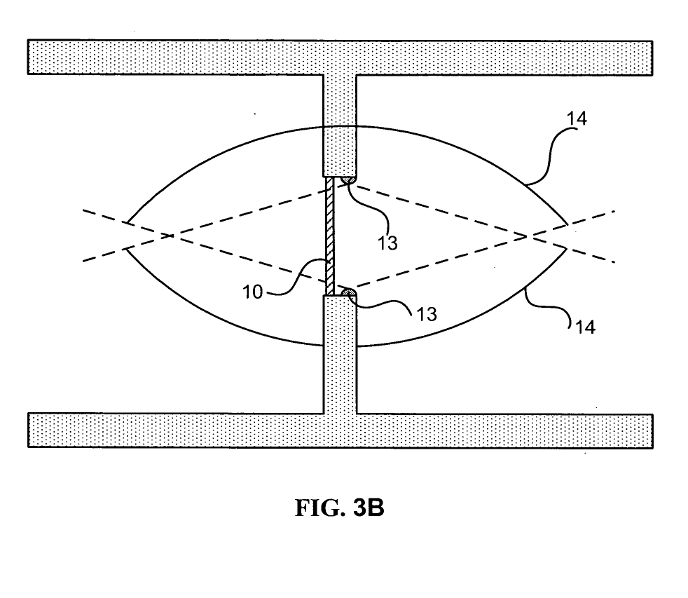

Referring to FIG. 3A, in an exemplary embodiment option of the present invention, identifying sensor 13 features a horizontal opening angle 14 for both sides of safety gate 10. FIG. 3B, illustrates two identifying sensors 13 featuring horizontal opening angles 14 for both sides of safety gate 10.

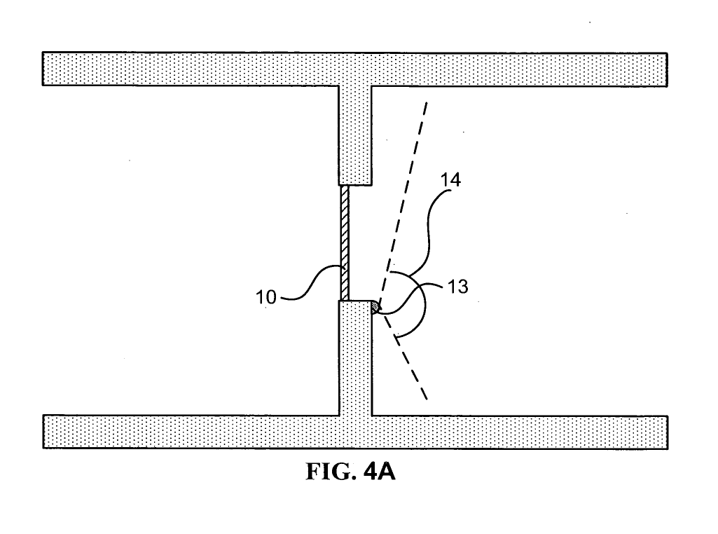

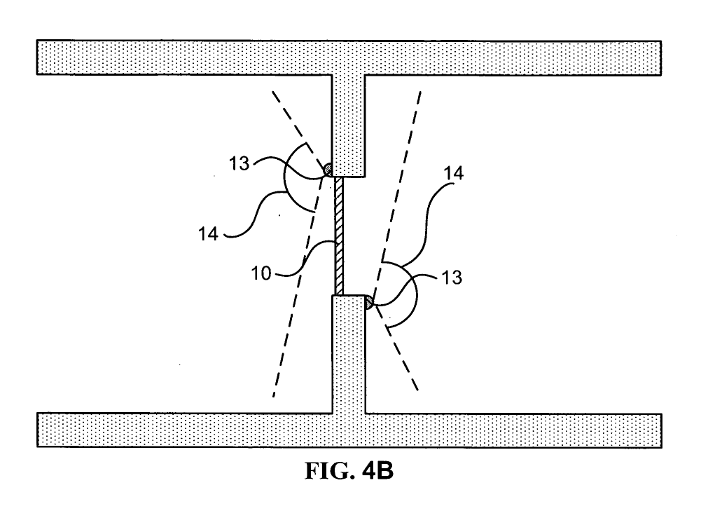

Referring to FIG. 4A, in an exemplary embodiment option of the present invention, identifying sensor 13 features a horizontal opening angle 14 for one side of safety gate 10. FIG. 4B, illustrates two identifying sensors 13 feature horizontal opening angles 14 for one side of safety gate 10.

In an exemplary embodiment option of the present invention, identifying sensor 13 is connected to the safety gate 10 using an electrical wired connection. Alternatively, identifying sensor 13 communicates with safety gate 10 by almost any known in the art wireless communication means, such as radio-frequency and/or infra-red communication devices.

In an exemplary embodiment option of the present invention, safety gate 10 and/or identifying sensor 13 are connected to an electrical source, such as, but not limited to, a wired AC, battery, or solar panel.

In an exemplary embodiment option of the present invention, identifying sensor 13 is a weight sensor, placed on the floor. The weight sensor measures the body weight of the person standing on it and identifies when an adult exceeds a predefined threshold.

Herein disclosed are a few exemplary identifying sensors and their configurations.

In an exemplary embodiment option of the present invention, an active sensor, featuring at least one electro-magnetic transmitter and at least one electro-magnetic receiver, is located at a position with a detection range above the predetermined height of the infant. Alternatively, identifying sensor 13 additionally may feature a reflecting element, such as a mirror.

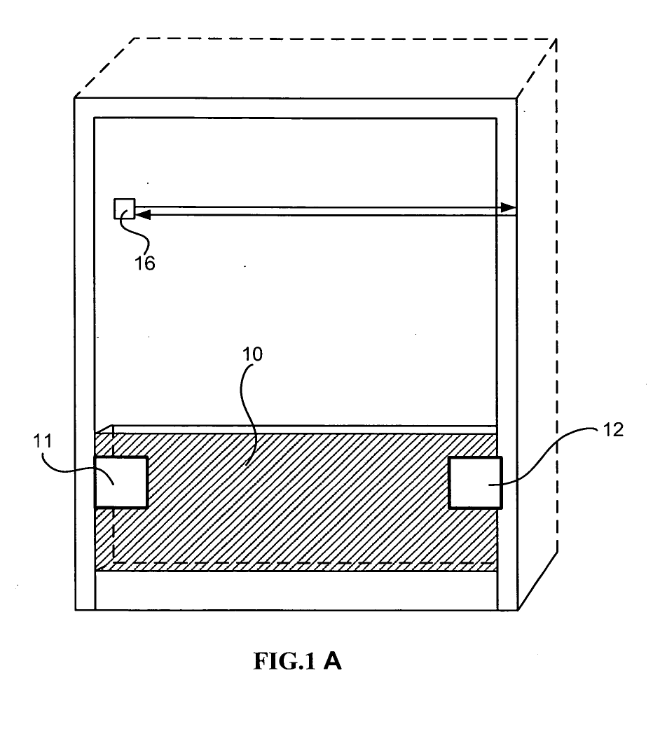

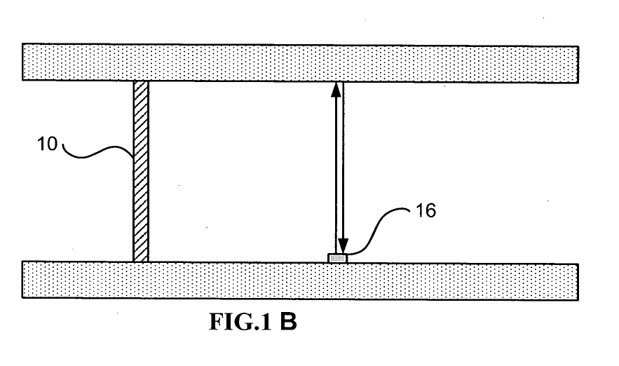

Referring to FIG. 1A and FIG. 1B, in an exemplary embodiment option of the present invention, a light emitting diode and appropriate receiver 16 are placed on one side of the doorway, and a mirror is placed on the other side of the doorway. When no beam reflections are received by the receiver, the system of the present invention may open safety gate 10.

In another exemplary embodiment option of the present invention, a passive infra red motion sensor, featuring a piezoelectric sensor and a Fresnel lens, making it sensitive to motion of hot bodies emission in the range between 8 and 4 μm, is located at a position with a detection range above the predetermined height of the infant.

In still another exemplary embodiment option of the present invention, a Radio Frequency Identification (RFID) reader is sensing the presence of an RFID tag connected to the infant or caregiver. In the first case as the tagged infant approaches a predefined distance from the gate—the gate automatically locks. In the second case the gate is always locked and the Tag is on the caregiver, as he/she approaches the gate only then does it unlock.

Opening and closing safety gate 10 may harm an infant in the vicinity of safety gate 10. In order to prevent this from occurring, in an exemplary embodiment option of the present invention, identifying sensor 13 identifies both the infant in the vicinity of safety gate 10 and an adult passing through safety gate 10. In this case, safety gate 10 may not change its current position when the infant is in the vicinity of safety gate 10. Moreover, the safety mechanism of the present invention may prevent safety gate 10 from closing on someone passing through safety gate 10.

In an exemplary embodiment option of the present invention, the present invention implements a noise cancellation algorithm that filters out disturbances in the detection range.

In an exemplary embodiment option of the present invention, safety gate 10 can be manually opened. This is useful when dealing with any kind of failure preventing the automatic operation of safety gate 10, in accordance with the present invention. Exemplary manual opening methods include the use of a handle placed on the safety gate 10, pushing a button, using a lever, or any other known in the art safety mechanism.

It is to be understood that the gate of the present invention may also be a swing gate, i.e. unlocking the actuator releases the lock and allows the user of the present invention to swing the gate open. Optionally the gate may be swing in any required direction. In this case, the swing hinge may be spring loaded to automatically close the gate behind the user.

It is appreciated that certain features of the invention that are, for clarity's sake, described in the context of separate embodiments, may also be provided in various combinations in a single embodiment. Conversely, various features of the invention, which are, for brevity, described in the context of a single embodiment, may also be provided separately or in any suitable sub-combination.

All publications, patents and patent applications mentioned in this specification are herein incorporated in their entirety by reference to the specification, to the same extent as if each individual publication, patent or patent application was specifically and individually indicated to be incorporated herein by reference. In addition, the citation or identification of any reference in this application shall not be construed as an admission that such reference is available as prior art to the present invention.

Any element in a claim that does not explicitly state “means for” performing a specific function, or “step for” performing a specific function, is not to be interpreted as a “means” or “step” clause as specified in 35 U.S.C. § 112, ¶6.

While the invention has been described in conjunction with specific embodiments and examples thereof, it is to be understood that they have been presented by way of example and not limitation. Moreover, it is evident that many alternatives, modifications and variations will be apparent to those skilled in the art. Accordingly, it is intended to embrace all such alternatives, modifications and variations falling within the spirit and broad scope of the appended claims and their equivalents.

What is claimed is:

1. A safety gate comprising:
at least one identifying sensor,
at least one safety gate,
at least one locking mechanism,
whereby the identifying sensor is activating the locking mechanism when an adult over a predefined height is identified by the identifying sensor.

2. The safety gate of claim 1, wherein the safety gate is a motorized safety gate and the identifying sensor is activating the motorized safety gate when an adult over a predefined height is identified by the identifying sensor.

3. The safety gate of claim 1, wherein the identifying sensor is selected from the group consisting of active detection sensor, passive detection sensor, motion detection sensor, heat detection sensor, acoustic detection sensor, electro-optic sensor, infra-red detection sensor, radio-frequency detection sensor, and microwave detection sensor.

4. A safety gate comprising:
at least one identifying sensor,
at least one safety gate,
at least one gate actuator,
whereby the identifying sensor is activating the gate actuator when an adult over a predefined height is identified by the identifying sensor.

5. The safety gate of claim 4, wherein the safety gate is further comprising a locking mechanism.

6. The safety gate of claim 4, wherein the identifying sensor is selected from the group consisting of active detection sensor, passive detection sensor, motion detection sensor, heat detection sensor, acoustic detection sensor, electro-optic sensor, infra-red detection sensor, radio-frequency detection sensor, and microwave detection sensor.

7. A safety gate comprising:
at least one electro-optic identifying sensor,
at least one safety gate,
at least one gate actuator,
whereby the identifying sensor is placed in such a way that an adult, but not an infant, can be inside the vertical opening angle of the identifying sensor.

8. The safety gate of claim 7, wherein the identifying sensor has a horizontal opening angle for at least one side of the safety gate.

9. The safety gate of claim 7, wherein the at least one identifying sensor comprises two identifying sensors having horizontal opening angles for at least one side of the safety gate.

10. A safety gate comprising:
at least one weight sensor,
at least one automatic safety gate,
wherein the weight sensor measures the body weight of a user and identifies when the user exceeds a predefined weight threshold.

11. A method for operating a motorized safety gate, the method comprising the steps of:
identifying an adult by using an identifying sensor selected from the group consisting of active detection sensor, passive detection sensor, motion detection sensor, heat detection sensor, acoustic detection sensor, electro-optic sensor, infra-red detection sensor, radio-frequency detection sensor, and microwave detection sensor; and
unlocking or opening at least one safety gate according to the adult identification.

12. The method of claim 11, wherein the adult is over a predefined height.

13. The method of claim 11, wherein the adult captures an opening angle larger than a predefined opening angle.

14. The method of claim 11, wherein the adult is using means for identifying himself.

15. The method of claim 11, wherein the identifying sensor is placed in such a way that the adult, but not an infant, can be inside the vertical opening angle of the identifying sensor.

16. The method of claim 11, further comprising the step of identifying an infant in the vicinity of the safety gate and not changing the current position of the safety gate when the infant is in the vicinity of the safety gate.
